(19) United States
(12) Patent Application Publication
(10) Pub. No.: US 2016/0183228 A1
(43) Pub. Date: Jun. 23, 2016

(54) METHOD AND APPARATUS FOR TRANSMITTING PHYSICAL CHANNEL

(71) Applicant: Electronics and Telecommunications Research Institute, Daejeon (KR)

(72) Inventors: Young Seog SONG, Daejeon (KR); Jun Hwan LEE, Seoul (KR); Il Gyu KIM, Chungcheongbuk-do (KR); Seung Chan BANG, Daejeon (KR)

(21) Appl. No.: 14/824,222

(22) Filed: Aug. 12, 2015

(30) Foreign Application Priority Data
Dec. 19, 2014 (KR) 10-2014-0184922

(51) Int. Cl. H04W 72/04; H04L 5/00

(52) U.S. Cl. CPC H04W 72/044; H04L 5/0048; H04W 72/0406

(57) ABSTRACT

A base station allocates a first frequency resource and a first time resource for first information that is included in a first physical channel and second information that is included in a second physical channel. The base station multi-transmits the first physical channel and the second physical channel through spatial multiplexing.

### CROSS-REFERENCE TO RELATED APPLICATION

This application claims priority to and the benefit of Korean Patent Application No. 10-2014-0184922 filed in the Korean Intellectual Property Office on Dec. 19, 2014, the entire contents of which are incorporated herein by reference.

### BACKGROUND OF THE INVENTION

(a) Field of the Invention

The present invention relates to a method and apparatus for transmitting a physical channel.

(b) Description of the Related Art

Currently, the number of users of a smart phone, a smart pad, and a tablet personal computer (PC) is rapidly increasing, and a wireless Internet traffic use amount is exceeding capacity of existing wideband code division multiple access (WCDMA), long term evolution (LTE), and WIFI. Accordingly, in an industrial field and a standardization organization such as 3rd Generation Partnership Project (3GPP), interest in using a high frequency band having a wider available frequency bandwidth than a frequency band that is used for existing cellular mobile communication in mobile communication has increased. In 3GPP, research on increasing communication capacity by using a high frequency band in a small cell has been performed. By measuring a propagation channel of a millimeter wave frequency band, some academic worlds and industrial fields determine a characteristic thereof and have produced and tested a mobile communication prototype apparatus using the propagation channel.

Use of a high frequency may enable an antenna size to be formed in a small size and thus a plurality of antennas may be mounted in a base station system. A plurality of beams may be transmitted within one sector through a plurality of antennas, and this enables operation of a base station system that can form a 2D beam and a 3D beam.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus having advantages of being capable of efficiently transmitting a physical channel in a communication system in which a multiple antenna is mounted.

An exemplary embodiment of the present invention provides a method in which a base station transmits a physical channel. The method includes: allocating a first frequency resource and a first time resource for first information that is included in a first physical channel and second information that is included in a second physical channel; and multi-transmitting the first physical channel and the second physical channel through spatial multiplexing.

A resource for a first pilot signal that is included in the first physical channel is the same as a resource for the first pilot signal that is included in the second physical channel.

The first information and the second information may be one of control information and data information.

The first pilot signal may be a cell specific reference signal that is transmitted to an entire area of a sector of the base station.

The method may further include: before the allocating of a first frequency resource, receiving feedback information from a terminal; and determining whether to multi-transmit the first physical channel and the second physical channel based on the feedback information.

The terminal may include a first terminal and a second terminal.

The feedback information may include first feedback information that is received from the first terminal and second feedback information that is received from the second terminal.

The first feedback information may include a first beam identifier representing a first beam of a plurality of beams and channel quality information of the first beam.

The first beam may correspond to a second pilot signal that is received by the first terminal.

The second pilot signal may be limited and transmitted to at least one of subdivided areas of the sector through the first beam.

The determining of whether to multi-transmit may include: determining whether the first beam identifier exists in the second feedback information; and determining, when the first beam identifier does not exist in the second feedback information, to multi-transmit the first physical channel and the second physical channel to the first terminal and the second terminal.

The channel quality information of the first beam may include at least one of a Signal-to-Noise Ratio (SNR), a Channel Quality Indicator (CQI), and Reference Signal Received Power (RSRP) of the first beam.

The sector may be subdivided by a plurality of beams.

The multi-transmitting of the first physical channel and the second physical channel may include: grouping a first area and a second area of subdivided areas of the sector into a first group; grouping a third area and a fourth area of the subdivided areas of the sector into a second group; and multi-transmitting the first physical channel to the first group and the second physical channel to the second group through spatial multiplexing.

The method may further include: before the allocating of a first frequency resource, receiving a reference signal from a terminal through at least one of a plurality of beams; and determining whether to multi-transmit the first physical channel and the second physical channel based on power of the reference signal.

The receiving of a reference signal from a terminal may include receiving a first reference signal of the reference signals from a first terminal of the terminals through at least one first beam of the plurality of beams.

The determining of whether to multi-transmit may include determining a first effective beam effective to the first terminal among the first beams by comparing received power of the first reference signal and a threshold value.

The receiving of a reference signal from a terminal may further include receiving a second reference signal of the reference signals from a second terminal of the terminals through at least one second beam of the plurality of beams.

The determining of whether to multi-transmit may further include determining a second effective beam effective to the second terminal among the second beams by comparing received power of the second reference signal and the threshold value.

The determining of whether to multi-transmit may further include determining to multi-transmit the first physical channel and the second physical channel to the first terminal and the second terminal, when an overlapped beam does not exist between the first effective beam and the second effective beam.

The first physical channel and the second physical channel may each include the same Pseudo Noise (PN) sequence for the first pilot signal.

The base station may operate a distributed plurality of antennas.

Another embodiment of the present invention provides a method in which a terminal transmits a signal to a base station that transmits a first pilot signal in an entire area of a service area. The method may includes: receiving at least one second pilot signal of second pilot signals that are limitedly transmitted to each of subdivided first areas of the service area by the base station; determining a channel quality of a first beam and a first beam identifier representing the first beam corresponding to the received second pilot signal of a plurality of beams; and transmitting a feedback signal including a channel quality of the first beam and the first beam identifier to the base station.

The service area may be subdivided into the plurality of first areas by the plurality of beams.

The determining of a channel quality of a first beam and a first beam identifier may include: determining a channel quality of the first beam including at least one of a Signal-to-Noise Ratio (SNR), a Channel Quality Indicator (CQI), and Reference Signal Received Power (RSRP) of the first beam; sorting channel qualities of the plurality of first beams in magnitude order, when the received second pilot signal is in plural and the first beam is in plural; and selecting at least one of the sorted channel qualities.

The transmitting of a feedback signal may include transmitting the feedback signal including the selected channel quality and the first beam identifier corresponding to the selected channel quality to the base station.

The method may further include receiving a first physical channel of the first physical channel and a second physical channel that are transmitted through spatial multiplexing of the base station.

A frequency resource and a time resource for the first pilot signal that is included in the first physical channel may be the same as a frequency resource and a time resource for the first pilot signal that is included in the second physical channel.

Yet another embodiment of the present invention provides a transmitting apparatus. The transmitting apparatus includes: an allocator that allocates the same first frequency-time resource for first information that is included in a first physical channel and second information that is included in a second physical channel; and a transmitter that multi-transmits the first physical channel and the second physical channel through spatial multiplexing.

A frequency-time resource for a first pilot signal that is included in the first physical channel is the same as a frequency-time resource for the first pilot signal that is included in the second physical channel.

The transmitting apparatus may further include a determination processor that determines whether to multi-transmit the first physical channel and the second physical channel based on feedback information that is received from a terminal.

### BRIEF DESCRIPTION OF THE DRAWINGS

FIG. 1 is a diagram illustrating a sector in which a base station is in charge and a subdivided area of the sector in a cellular mobile communication system.

FIG. 2 is a diagram illustrating a base station operating a distributed plurality of antennas.

FIGS. 3 and 4 are diagrams illustrating an area in which a physical channel is multi-transmitted.

FIG. 5 is a diagram illustrating a case in which a base station multi-transmits two streams according to an exemplary embodiment of the present invention.

FIG. 6 is a flowchart illustrating a process in which a terminal transmits feedback information to a base station based on a second pilot signal.

FIG. 7 is a flowchart illustrating a process in which a base station multi-transmits a physical channel based on feedback information.

FIG. 8 is a flowchart illustrating a process in which a base station multi-transmits a physical channel based on a reference signal of a terminal.

FIG. 9 is a block diagram illustrating a configuration of a base station.

FIG. 10 is a block diagram illustrating a configuration of a terminal.

FIG. 11 is a view illustrating a computer system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In an entire specification, a terminal may indicate a mobile terminal (MT), a mobile station (MS), an advanced mobile station (AMS), a high reliability mobile station (HR-MS), a subscriber station (SS), a portable subscriber station (PSS), an access terminal (AT), and user equipment (UE), and may include an entire function or a partial function of the MT, the MS, the AMS, the HR-MS, the SS, the PSS, the AT, and the UE.

Further, a base station (BS) may indicate an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) that performs a function of the BS, a high reliability relay station (HR-RS) that performs a function of the BS, and a small-sized BS, and may include an entire function or a partial function of the BS, the ABS, the HR-BS, the nodeB, the eNodeB, the AP, the RAS, the BTS, the MMR-BS, the RS, the HR-RS, and the small-sized BS.

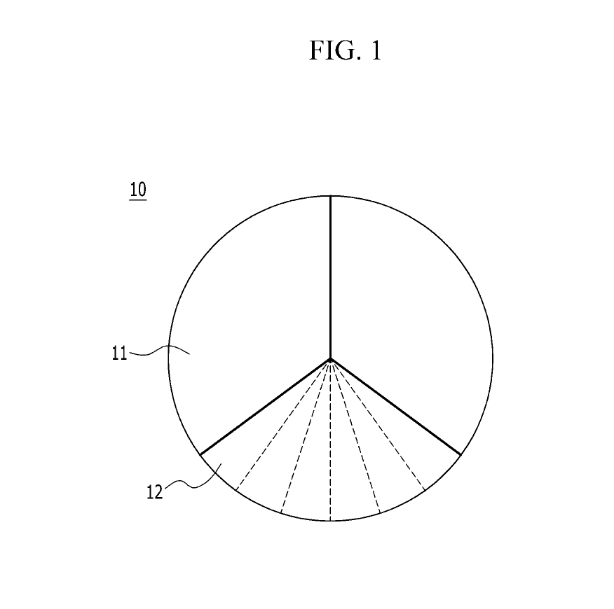

FIG. 1 is a diagram illustrating a sector 11 that a base station is in charge of and an area 12 that is subdivided by a directional beam of the sector 11 in a cellular mobile communication system. A cell 10 includes a plurality of sectors 11.

A base station system operating a plurality of antennas may subdivide one sector 11 to transmit a beam. Specifically, the sector 11 that a base station is in charge of may be two-dimensionally subdivided into a plurality of areas 12 through a plurality of directional beams. The base station may three-dimensionally subdivide the sector 11 using a three-dimensional beam. The directional beam may be implemented with a horn antenna or a patch array antenna. A plurality of directional beams that cover the sector 11 may be implemented with a horn antenna array in which directions of each directional beams are different. Alternatively, a plurality of directional beams that cover the sector 11 may be implemented with a plurality of patch array antennas. Each patch array antenna generates a fixed directional beam and may be disposed in different directions like the horn antenna array. Alternatively, a plurality of directional beams that cover the sector 11 may be implemented using a structure that couples an analog phase shifter to a patch array antenna. Alternatively, a plurality of directional beams that cover the sector 11 may be implemented using a structure forming a directional beam by adjusting a coefficient in a digital beamforming.

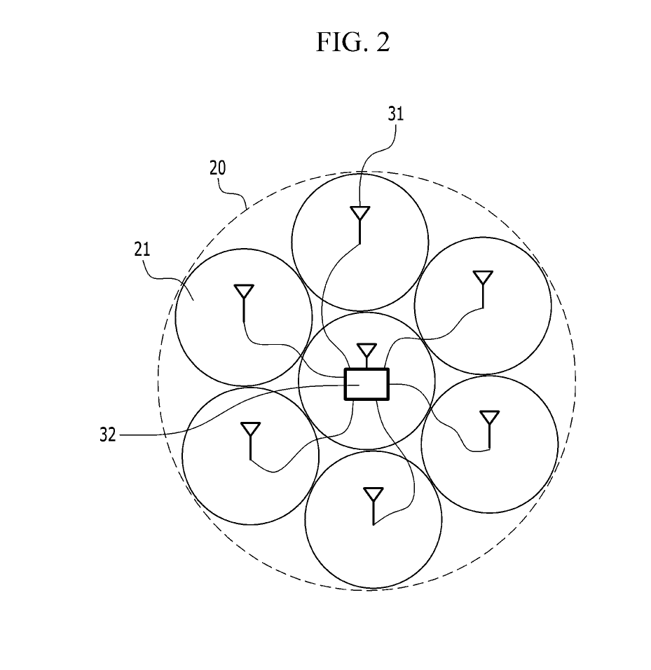

FIG. 2 is a diagram illustrating a base station operating a distributed plurality of antennas. A wireless service area 20 includes a plurality of subdivided areas 21 that are divided by an omnidirectional beam that is emitted from a plurality of antennas. The service area 20 may be the sector 11 that a base station is in charge of.

Due to a rapid increase of wireless traffic, a cellular communication system may dispose a small cell by increasing the number of base stations per unit area. Further, the base station may operate a distributed plurality of antennas. Specifically, the base station includes a plurality of Radio Frequency (RF) modules 31 and a digital signal processing module 32. The RF module 31 that is connected to an antenna is installed in each subdivided area 21, and the module 32 that processes a digital signal is disposed at one location. Each RF module 31 and the digital signal processing module 32 are interlocked.

In FIGS. 1 and 2, one purpose of the cellular communication system that uses a multiple antenna (e.g., centralized Multiple-Input Multiple-Output (MIMO) antenna, distributed MIMO antenna) is to increase entire throughput. In order to increase throughput, by efficiently performing multiplex transmission, the base station should avoid interference between simultaneously transmitted multiple streams. As interference reduces, a transmission speed of each multiple stream may increase.

Hereinafter, a multi-transmitting method of a cellular communication system (hereinafter, ‘multiple antenna system’) using a multiple antenna will be described. Further, when the base station transmits a physical channel (e.g., control channel, traffic channel) through a plurality of antennas, a method in which the base station sends a pilot signal will be described. A method in which the base station operates a control channel and a traffic channel will be described.

Hereinafter, for convenience of description, a sector 11 and a service area 20 that the base station is in charge of is referred to as a sector, a directional beam that is transmitted to cover an entire area of the sectors 11 and 20 is referred to as a beam, and an area in which a beam is spread is referred to as a beam area. The subdivided area 12 of the sector 11 and the subdivided area 21 of the service area 20 are beam areas.

In FIGS. 1 and 2, a Line Of Sight (LOS) channel is assumed and beam areas 12 and 21 are illustrated. Due to overlapping of a beam or reflection of a beam by a building, respective beam areas 12 and 21 may be overlapped with other beam areas 12 and 21. The beam area 21 of FIG. 2 has a shape of a disc by an omnidirectional beam that is emitted from an omnidirectional antenna.

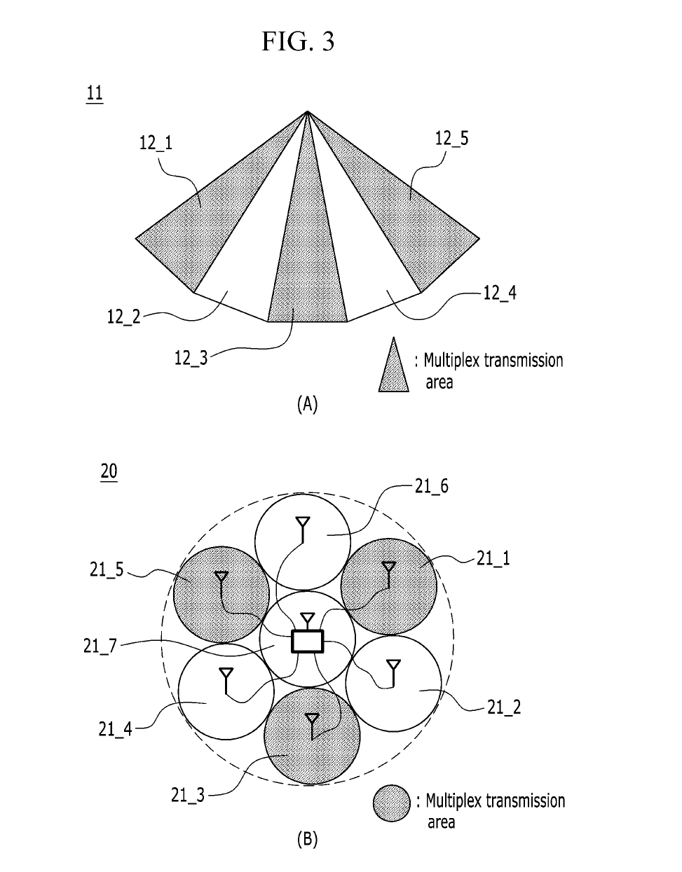

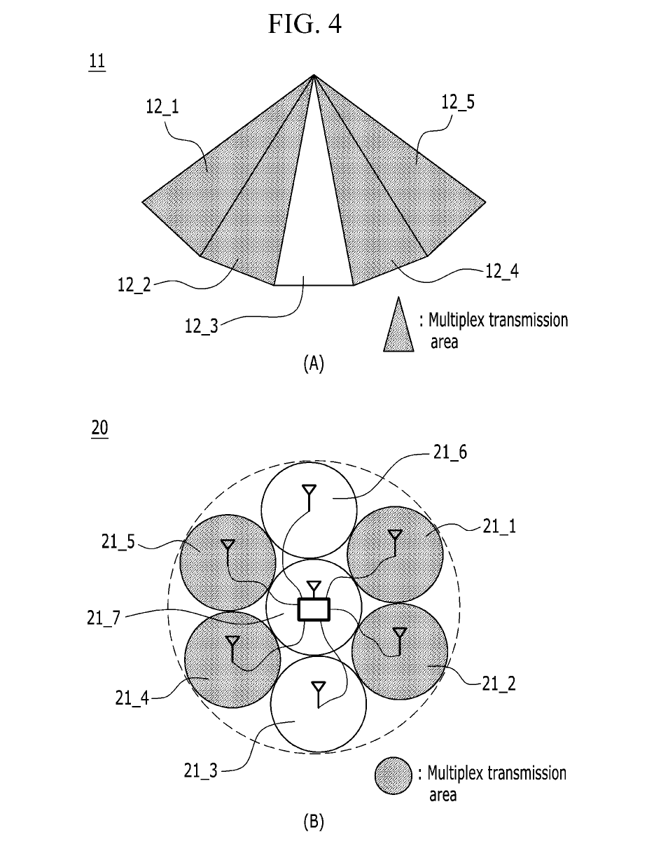

FIGS. 3 and 4 are diagrams illustrating an area in which a physical channel is multi-transmitted.

The physical channel is formed with physical channel information and a pilot signal. In a multiple antenna system of FIGS. 1 and 2, a first pilot signal (e.g., a cell specific reference signal (C-RS)) is transmitted to an entire area of the sectors 11 and 20, each of a plurality of second pilot signals is limitedly transmitted to respective beam areas 12 and 21. Specifically, when a first pilot signal is transmitted, the same sequence is simultaneously transmitted through an entire beam within the sectors 11 and 20. When the second pilot signal is transmitted, the same Pseudo Noise (PN) sequence or a different PN sequence is used on each beam basis, and the second pilot signal may be transmitted at a different resource location. Because the first pilot signal should be transmitted to the entirety of the sectors 11 and 20, the first pilot signal may be used as a reference signal for transmission of a channel that should be transmitted to the entirety of the sectors 11 and 20 such as a physical broadcasting channel (PBCH) of an LTE specification or a control channel.

The base station may multi-transmit a control channel and a traffic channel using a characteristic that can subdivide a communication area. Specifically, FIG. 3 illustrates a case in which the base station multi-transmits a control channel and a traffic channel using a first pilot signal as a reference signal. The first pilot signal is transmitted to the entirety of the sectors 11 and 20. Information of a physical channel (e.g., control channel, traffic channel) is multi-transmitted to be transmitted with different values to beam areas 12 and 21, but in a situation in which the beam areas 12 and 21 may be separated, interference does not occur and thus each terminal may demodulate received information of the physical channel.

Specifically, FIG. 3 illustrates a case in which the base station multi-transmits three physical channels in three beam areas 12 and 21, and FIG. 4 illustrates a case in which the base station multi-transmits two physical channels in two beam areas 12 and 21. In FIGS. 3 and 4, the sector 11 includes beam areas 12_1-12_5 corresponding to the beam area 12, and the sector 20 includes beam areas 21_1-21_7 corresponding to the beam area 21.

As shown in (A) of FIG. 3, the base station may multi-transmit a physical channel to three beam areas 12_1, 12_3, and 12_5 through spatial multiplexing. Alternatively, as shown in (B) of FIG. 3, the base station may multi-transmit a physical channel to three beam areas 21_1, 21_3, and 21_5 through spatial multiplexing. Alternatively, as shown in (A) of FIG. 4, the base station may combine two beam areas 12_1 and 12_2 into one, combine two beam areas 12_4 and 12_5 into one, and multi-transmit two physical channels to two bundle areas through spatial multiplexing. Alternatively, as shown in (B) of FIG. 4, the base station may combine two beam areas 21_1 and 21_2 into one and combine two beam areas 21_4 and 21_5 into one to multi-transmit two physical channels to two bundle areas through spatial multiplexing.

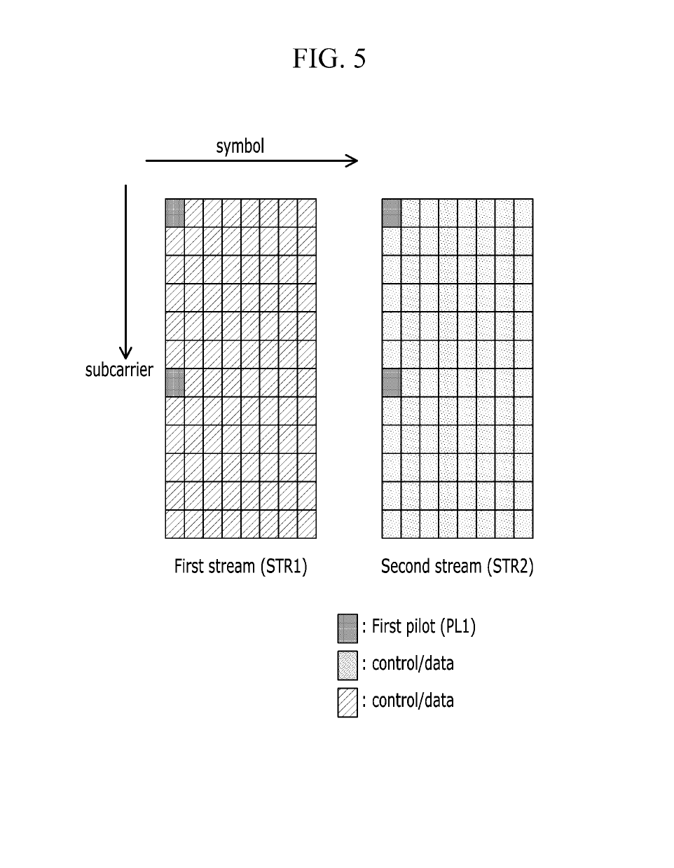

FIG. 5 is a diagram illustrating a case in which a base station multi-transmits two streams according to an exemplary embodiment of the present invention. Specifically, FIG. 5 illustrates a case in which the base station multi-transmits a first stream STR1 and a second stream STR2 through spatial multiplexing in an Orthogonal Frequency Division Multiple Access (OFDMA) system. In FIG. 5, for convenience of description, a physical channel corresponding to the first stream STR1 is referred to as a first physical channel and a physical channel corresponding to the second stream STR2 is referred to as a second physical channel.

The base station allocates different information (e.g., control information, data information) to the same resource. For example, when the first physical channel and the second physical channel are control channels, the base station allocates the same frequency resource (subcarrier) and the same time resource (symbol) for control information of the first physical channel and control information of the second physical channel. Alternatively, when the first physical channel and the second physical channel are traffic channels, the base station allocates the same frequency resource and the same time resource for data (traffic) information of the first physical channel and data information of the second physical channel.

A resource allocation location for a first pilot signal PL1 of the first physical channel is the same as the resource allocation location for a first pilot signal PL1 of the second physical channel. Specifically, the frequency resource and the time resource for the first pilot signal PL1 of the first physical channel are the same as those for the first pilot signal PL1 of the second physical channel. The first pilot signal PL1 of the first physical channel and the first pilot signal PL1 of the second physical channel use (include) the same PN sequence.

The base station multi-transmits a first stream STR1 and a second stream STR2 through spatial multiplexing.

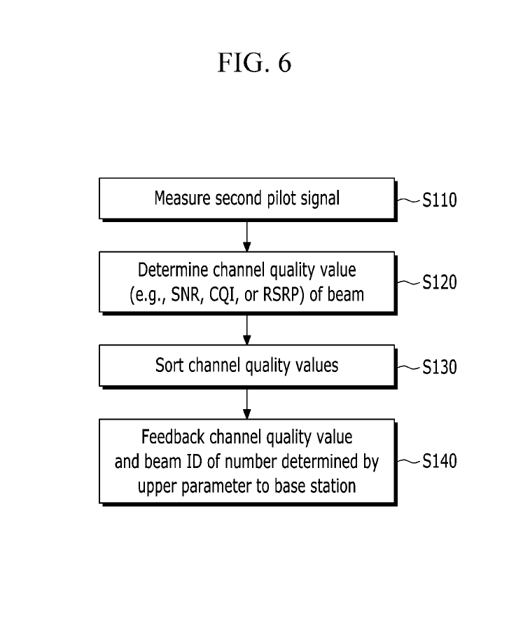

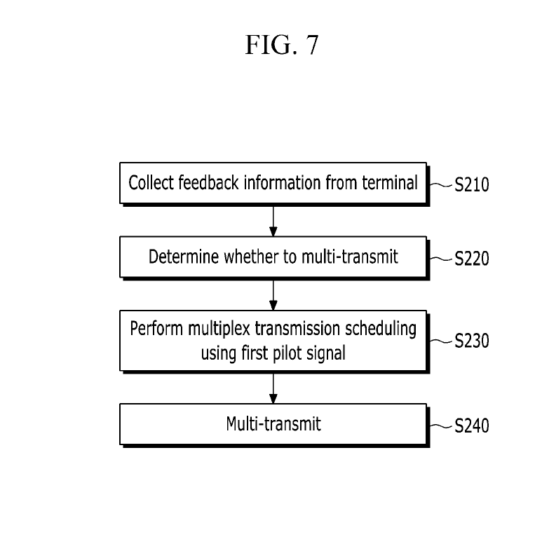

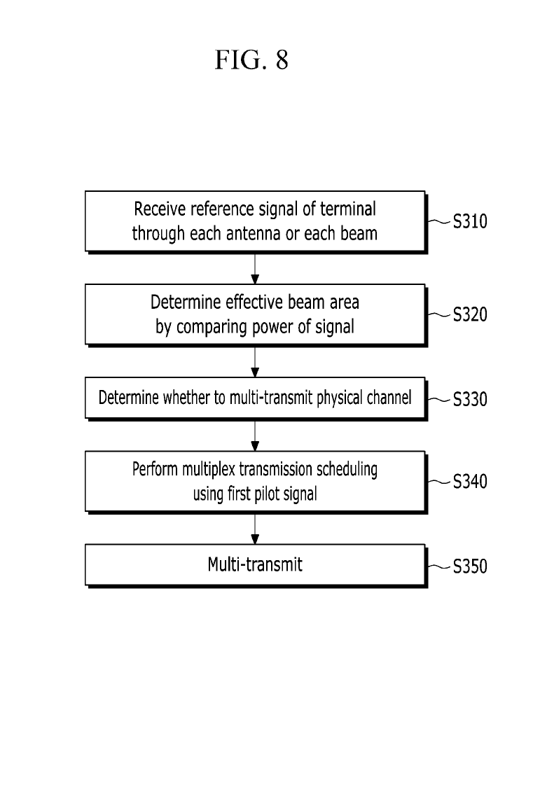

The base station (or another communication apparatus) may determine whether to multi-transmit a physical channel according to whether overlapping of beam areas 12 and 21 exists. Specifically, a method in which the base station determines whether the beam areas 12 and 21 are overlapped includes a first method and a second method. The first method is a method in which the base station determines whether the beam areas 12 and 21 are overlapped based on feedback information that is received from a terminal. The second method is a method in which the base station determines whether the beam areas 12 and 21 are overlapped based on a reference signal that is transmitted from a terminal. The first method will be described with reference to FIGS. 6 and 7, and the second method will be described with reference to FIG. 8. For convenience of description, a case in which the base station supports a sector 20 including a plurality of beams area 21 is assumed, and will be described with reference to FIGS. 6 to 8. The first method and the second method may be applied even to a case in which the base station supports the sector 11 including a plurality of beams areas 12.

FIG. 6 is a flowchart illustrating a process in which a terminal transmits feedback information to a base station based on a second pilot signal.

The terminal receives a second pilot signal that is limitedly transmitted to each beam area 21 by the base station and measures the received second pilot signal (S110). Specifically, the terminal may receive one or a plurality of second pilot signals.

The terminal determines a channel quality value corresponding to the received second pilot signal (S120). Specifically, the terminal may determine (measure) the received second pilot signal and determine (measure) a Signal-to-Noise Ratio (SNR), a Channel Quality Indicator (CQI), Reference Signal Received Power (RSRP), or a combination thereof of the beam area 21. For example, when the terminal receives two second pilot signals in the process S110, the terminal may measure an SNR of a beam (hereinafter, ‘first beam’) corresponding to one of the received second pilot signal and an SNR of a beam (hereinafter, ‘second beam’) corresponding to the remaining one.

When there are multiple channel quality values determined in the process S120, the terminal sorts the channel quality values in magnitude order (S130). For example, when the terminal determines an SNR of the first beam and an SNR of the second beam in the process S120, the SNR of the first beam and the SNR of the second beam are sorted in magnitude order.

The terminal selects channel quality values of a number that a superordinate parameter (an upper parameter) designates among sorted channel quality values, and feeds back the selected channel quality values to the base station (S140). For example, in the process S130, an SNR of the first beam and an SNR of the second beam are sorted in magnitude order, and when the number that is determined by the superordinate parameter (the upper parameter) is two, the terminal may generate feedback information including ID and an SNR of the first beam and ID and an SNR of the second beam to transmit the feedback information to the base station.

FIG. 7 is a flowchart illustrating a process in which a base station multi-transmits a physical channel based on feedback information. Specifically, FIG. 7 illustrates a process of determining whether the base station is to multi-transmit a physical channel based on direct feedback of the terminal of FIG. 6.

The base station receives and collects feedback information from the terminal (S210). Specifically, when the base station receives a plurality of feedback information from a plurality of terminals, the base station may collect the feedback information together with ID of the terminal having transmitted the feedback information.

The base station determines whether to multi-transmit or to broadcast a physical channel based on the feedback information (S220). Specifically, when the base station determines that beams 21 corresponding to a beam ID that is fed back from a plurality of terminals have less mutual interference, the base station may determine to multi-transmit a physical channel to the terminal having transmitted feedback information. For example, when it is assumed that the base station receives first feedback information from a first terminal and receives second feedback information from a second terminal, if an overlapped beam ID does not exist in beam ID that is included in the first feedback information and beam ID that is included in the second feedback information, the base station may determine that a beam corresponding to beam ID of the first feedback information and a beam corresponding to beam ID of the second feedback information have less mutual interference. More specifically, when it is assumed that first beam ID (ID of the first beam) and second beam ID (ID of the second beam) are included in the first feedback information and third beam ID (different from the first beam ID and the second beam ID) and fourth beam ID (different from the first beam ID to the third beam ID) are included in the second feedback information, an overlapped beam ID does not exist in the first feedback information and the second feedback information and thus the base station may determine to multi-transmit a physical channel to the first terminal and the second terminal.

When the base station determines to multi-transmit a physical channel, the base station performs multiplex transmission scheduling using a first pilot signal PL1 (S230). Specifically, the base station may perform the above-described operation of FIG. 5. After multi-transmitting scheduling is performed, the base station multi-transmits a physical channel to the terminal through spatial multiplexing (S240).

FIG. 8 is a flowchart illustrating a process in which a base station multi-transmits a physical channel based on a reference signal of a terminal.

When the terminal transmits a control channel or a traffic channel to the base station, the terminal transmits a reference signal (e.g., a sounding reference signal) that the base station knows to the base station. The base station may use a reference signal from the terminal to measure channel quality for uplink traffic transmission.

The base station receives a reference signal of the terminal through each antenna or each beam that charges the beam area 21 (S310). Each antenna or each beam may correspond to each beam area 21. Specifically, the base station may receive a reference signal through at least one beam or antenna. Hereinafter, a ‘beam or an antenna’ is referred to as a ‘beam/antenna’.

The base station compares power of a reference signal that is received through each beam/antenna and a threshold value, and determines an effective beam area 21 (S320). Determine the beam area 21 includes determining a beam. For example, when it is assumed that the base station receives a reference signal that is transmitted by a first terminal through a first beam/antenna and a second beam/antenna of a plurality of beams/antennas, if power of a reference signal that is received through the first beam/antenna is larger than a threshold value and if power of a reference signal that is received through a second beam/antenna is smaller than a threshold value, the base station may determine a beam corresponding to a first beam/antenna among a plurality of beams as an effective beam for the first terminal. For another example, when it is assumed that the base station receives a reference signal that is transmitted by a second terminal through a third beam/antenna and a fourth beam/antenna of a plurality of beams/antennas, if each of power of a reference signal that is received through a third beam/antenna and power of a reference signal that is received through the fourth beam/antenna is a threshold value or more, the base station may determine a beam corresponding to the third beam/antenna of a plurality of beams and a beam corresponding to the fourth beam/antenna as an effective beam for the second terminal.

When effective beams for a plurality of terminals are not overlapped, the base station may determine to multi-transmit a physical channel (S330). For example, when an effective beam (e.g., a first beam) for the first terminal and an effective beam (e.g., a second beam) for the second terminal are different, the base station may determine to multi-transmit a physical channel to the first terminal and the second terminal. When it is determined that the base station multi-transmits the physical channel, the base station performs multiplex transmission scheduling using a first pilot signal PL1 (S340). Specifically, the base station may perform the above-described operation of FIG. 5. After multi-transmit scheduling is performed, the base station multi-transmits a physical channel to the terminal through spatial multiplexing (S350).

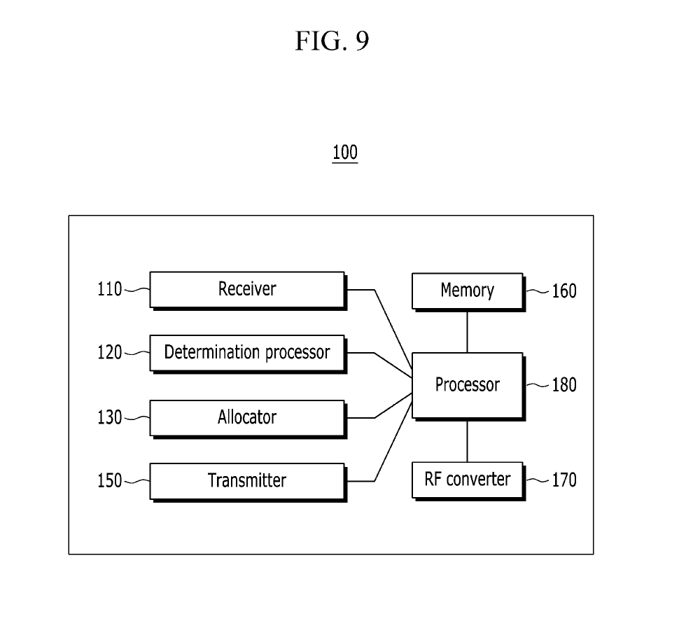

FIG. 9 is a block diagram illustrating a configuration of a base station 100.

The base station 100 includes a receiver 110, a determination processor 120, an allocator 130, a transmitter 150, a memory 160, a radio frequency (RF) converter 170, and a processor 180.

When the base station 100 is designed to use the first method, the receiver 110 may receive feedback information from a terminal. Specifically, the receiver 110 may perform an operation that is related to reception of feedback information that is described with reference to FIGS. 6 and 7. Alternatively, when the base station 100 is designed to use the second method, the receiver 110 may receive a reference signal from a terminal. Specifically, the receiver 110 may perform an operation that is related to reception of a reference signal that is described with reference to FIG. 8.

When the base station 100 is designed to use the first method, the determination processor 120 may determine whether to multi-transmit a physical channel or to broadcast based on feedback information of a terminal. Specifically, the determination processor 120 may perform an operation that is related to determination of whether multiplex transmission that is described with reference to FIGS. 6 and 7 is to be used. Alternatively, when the base station 100 is designed to use the second method, the determination processor 120 may determine whether to multi-transmit a physical channel or to broadcast based on a reference signal of a terminal. Specifically, the determination processor 120 may perform an operation that is related to determination of whether multiplex transmission that is described with reference to FIG. 8 is to be used.

The allocator 130 allocates the same frequency resource and the same time resource for different information (e.g., control information). Specifically, the allocator 130 may perform an operation that is related to allocation of a resource for information of the physical channel that is described with reference to FIG. 5.

A frequency-time resource for a first pilot signal PL1 of each of a plurality of physical channels is the same.

When it is determined that the determination processor 120 multi-transmits a physical channel, the transmitter 150 multi-transmits a physical channel through spatial multiplexing. When it is determined that the determination processor 120 broadcasts a physical channel, the transmitter 150 broadcasts a physical channel.

The memory 160 is connected to the processor 180 and stores various information that is related to operation of the processor 180.

The RF converter 170 is connected to the processor 180 and transmits or receives a wireless signal.

The processor 180 may be formed to implement a procedure, a function, and a method that are related to a base station that is described with reference to FIG. 8. Each of elements 110-170 may be executed by the processor 180.

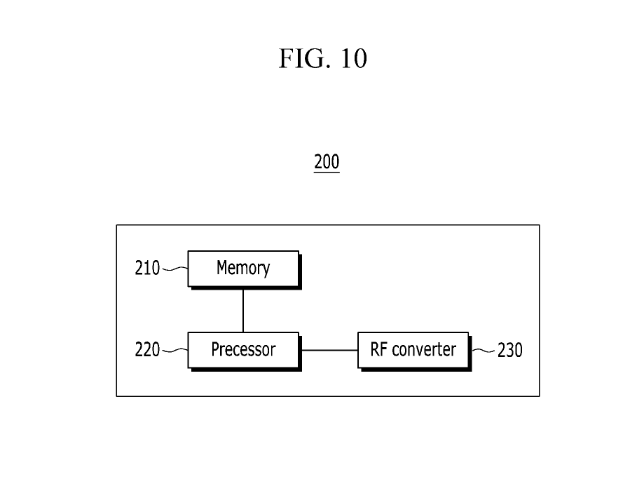

FIG. 10 is a block diagram illustrating a configuration of a terminal 200.

The terminal 200 includes a memory 210, a processor 220, and an RF converter 230.

The processor 220 may be formed to implement a procedure, a function, and a method that are related to a terminal that is described with reference to FIGS. 1 to 8.

The memory 210 is connected to the processor 220 and stores various information that is related to operation of the processor 220.

The RF converter 230 is connected to the processor 220 and transmits or receives a wireless signal. The terminal 200 may have a single antenna or a multiple antenna.

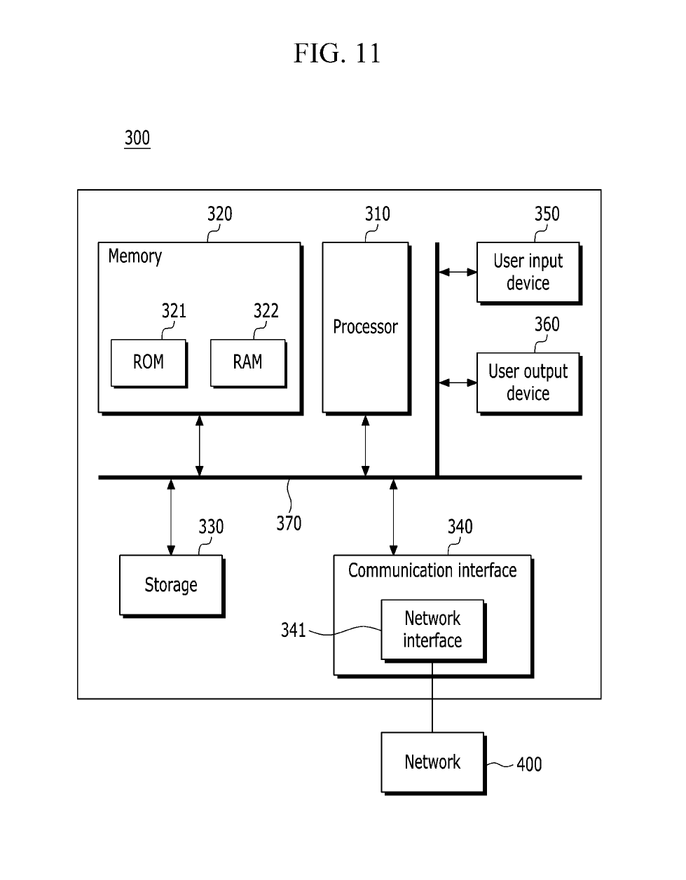

Meanwhile, an embodiment of the present invention may be implemented in a computer system, e.g., as a computer readable medium. As shown in FIG. 11, a computer system 300 may include one or more of a processor 310, a memory 320, and a storage 330. The computer system 300 may further include a communication interface 340. The communication interface 340 may include a network interface 341 that is coupled to a network 400. The computer system 300 may further include a user input device 350 and a user output device 360. Each of elements 310-360 may communicates through a bus 370.

The processor 310 may be a central processing unit (CPU) or a semiconductor device that executes processing instructions stored in the memory 320 and/or the storage 330. The memory 320 and the storage 330 may include various forms of volatile or non-volatile storage media. For example, the memory 320 may include a read-only memory (ROM) 321 and a random access memory (RAM) 322.

Accordingly, an embodiment of the invention may be implemented as a computer implemented method or as a non-transitory computer readable medium with computer executable instructions stored thereon. In an embodiment, when executed by the processor 310, the computer executable instructions may perform a method according to at least one aspect of the invention.

According to an exemplary embodiment of the present invention, in a cellular communication system including a base station operating a plurality of antennas or a base station operating a distributed plurality of antennas, a physical channel can be efficiently multi-transmitted.

An exemplary embodiment of the present invention may be applied to when the terminal 200 transmits a physical channel as well as when the base station 100 transmits a physical channel. Further, an exemplary embodiment of the present invention may be applied to communication between independent terminals in which a multiple antenna is mounted as well as a cellular communication system, and in this case, a terminal can efficiently multi-transmit a physical channel.

According to an exemplary embodiment of the present invention, by allocating control channel information of a plurality of terminals to the same resource and by multi-transmitting a control channel, capacity of the control channel can be increased.

Further, according to an exemplary embodiment of the present invention, a resource that is used for transmission of a control channel can be saved, and the saved resource can be used as a resource for transmitting a traffic channel and thus capacity of the traffic channel can be increased.

In addition, according to an exemplary embodiment of the present invention, by allocating traffic data of a plurality of terminals to the same resource and by multi-transmitting a traffic channel using the same pilot, throughput of the traffic channel can be increased.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a base station transmits a physical channel, the method comprising:
allocating a first frequency resource and a first time resource for first information that is included in a first physical channel and second information that is included in a second physical channel; and
multi-transmitting the first physical channel and the second physical channel through spatial multiplexing,
wherein a resource for a first pilot signal that is included in the first physical channel is the same as a resource for the first pilot signal that is included in the second physical channel.

2. The method of claim 1, wherein each of the first information and the second information is one of control information and data information, and
the first pilot signal is a cell specific reference signal that is transmitted to an entire area of a sector of the base station.

3. The method of claim 2, further comprising: before the allocating of a first frequency resource,
receiving feedback information from a terminal; and
determining whether to multi-transmit the first physical channel and the second physical channel based on the feedback information.

4. The method of claim 3, wherein the terminal comprises a first terminal and a second terminal,
the feedback information comprises first feedback information that is received from the first terminal and second feedback information that is received from the second terminal, and
the first feedback information comprises a first beam identifier representing a first beam of a plurality of beams and channel quality information of the first beam.

5. The method of claim 4, wherein the first beam corresponds to a second pilot signal that is received by the first terminal, and
the second pilot signal is limited and transmitted to at least one of subdivided areas of the sector through the first beam.

6. The method of claim 5, wherein the determining of whether to multi-transmit comprises:
determining whether the first beam identifier exists in the second feedback information; and
determining, when the first beam identifier does not exist in the second feedback information, to multi-transmit the first physical channel and the second physical channel to the first terminal and the second terminal.

7. The method of claim 4, wherein the channel quality information of the first beam comprises at least one of a Signal-to-Noise Ratio (SNR), a Channel Quality Indicator (CQI), and Reference Signal Received Power (RSRP) of the first beam.

8. The method of claim 2, wherein the sector is subdivided by a plurality of beams, and
the multi-transmitting of the first physical channel and the second physical channel comprises:
grouping a first area and a second area of subdivided areas of the sector into a first group;
grouping a third area and a fourth area of the subdivided areas of the sector into a second group; and
multi-transmitting the first physical channel to the first group and the second physical channel to the second group through spatial multiplexing.

9. The method of claim 2, further comprising: before the allocating of a first frequency resource,
receiving a reference signal from a terminal through at least one of a plurality of beams; and
determining whether to multi-transmit the first physical channel and the second physical channel based on power of the reference signal.

10. The method of claim 9, wherein the receiving of a reference signal from a terminal comprises receiving a first reference signal of the reference signals from a first terminal of the terminals through at least one first beam of the plurality of beams, and
the determining of whether to multi-transmit comprises determining a first effective beam effective to the first terminal among the first beams by comparing received power of the first reference signal and a threshold value.

11. The method of claim 10, wherein the receiving of a reference signal from a terminal further comprises receiving a second reference signal of the reference signals from a second terminal of the terminals through at least one second beam of the plurality of beams, and
the determining of whether to multi-transmit further comprises determining a second effective beam effective to the second terminal among the second beams by comparing received power of the second reference signal and the threshold value.

12. The method of claim 11, wherein the determining of whether to multi-transmit further comprises determining to multi-transmit the first physical channel and the second physical channel to the first terminal and the second terminal, when an overlapped beam does not exist between the first effective beam and the second effective beam.

13. The method of claim 1, wherein the first physical channel and the second physical channel each comprise the same Pseudo Noise (PN) sequence for the first pilot signal.

14. The method of claim 1, wherein the base station operates a distributed plurality of antennas.

15. A method in which a terminal transmits a signal to a base station that transmits a first pilot signal in an entire area of a service area, the method comprising:
receiving at least one second pilot signal of second pilot signals that are limitedly transmitted to each of subdivided first areas of the service area by the base station;
determining a channel quality of a first beam and a first beam identifier representing the first beam corresponding to the received second pilot signal of a plurality of beams; and
transmitting a feedback signal comprising a channel quality of the first beam and the first beam identifier to the base station,
wherein the service area is subdivided into the plurality of first areas by the plurality of beams.

16. The method of claim 15, wherein the determining of a channel quality of a first beam and a first beam identifier comprises:
determining a channel quality of the first beam comprising at least one of a Signal-to-Noise Ratio (SNR), a Channel Quality Indicator (CQI), and Reference Signal Received Power (RSRP) of the first beam;
sorting channel qualities of the plurality of first beams in magnitude order, when the received second pilot signal is in plural and the first beam is in plural; and
selecting at least one of the sorted channel qualities.

17. The method of claim 16, wherein the transmitting of a feedback signal comprises transmitting the feedback signal comprising the selected channel quality and the first beam identifier corresponding to the selected channel quality to the base station.

18. The method of claim 17, further comprising receiving a first physical channel of the first physical channel and a second physical channel that are transmitted through spatial multiplexing of the base station,
wherein a frequency resource and a time resource for the first pilot signal that is included in the first physical channel are the same as a frequency resource and a time resource for the first pilot signal that is included in the second physical channel.

19. A transmitting apparatus, comprising:
an allocator that allocates the same first frequency-time resource for first information that is included in a first physical channel and second information that is included in a second physical channel; and
a transmitter that multi-transmits the first physical channel and the second physical channel through spatial multiplexing,
wherein a frequency-time resource for a first pilot signal that is included in the first physical channel is the same as a frequency-time resource for the first pilot signal that is included in the second physical channel.

20. The transmitting apparatus of claim 19, further comprising a determination processor that determines whether to multi-transmit the first physical channel and the second physical channel based on feedback information that is received from a terminal.
